(19) United States
(12) Patent Application Publication
(10) Pub. No.: US 2011/0258785 A1
(43) Pub. Date: Oct. 27, 2011

(54) Combination Electric Knife and Mixer

(76) Inventor: Magnini Kristy Diabate, Laurel, MD (US)

(21) Appl. No.: 13/093,955

(22) Filed: Apr. 26, 2011

Related U.S. Application Data
(60) Provisional application No. 61/327,953, filed on Apr. 26, 2010.

(51) Int. Cl. A47J 43/28; B26B 9/02; A47J 43/07

(52) U.S. Cl. 7/113

(57) ABSTRACT

A combination electric carving knife and mixer embodying both carving knife and mixer functions in a single device, and constructed so that knife and mixer attachments utilize the same receiving chamber in the device. The knife and mixer attachments are powered by motorized pistons that operate on the knife attachments for cutting and on the mixer attachment for mixing. The mixer attachment translates the linear motion of the pistons into a spinning motion by means of a conventional motion converter placed within the mixer attachment.

### CONTINUITY DATA

This is a non-provisional patent application claiming priority to U.S. provisional patent application No. 61/327,953 , filed on Apr. 26, 2010.

### FIELD OF THE PRESENT INVENTION

The present invention relates to a combination electric carving knife and mixer embodying both knife and mixer functions in a single device, and constructed so that the knife and mixer attachments both utilize the same receiving chamber in the device. The knife and mixer attachments are powered by motorized pistons that operate on the knife attachments for cutting and on the mixer attachment for mixing. The mixer attachment translates the linear motion of the pistons into a spinning motion by means of a conventional motion converter contained within the mixer attachment.

### BACKGROUND OF THE PRESENT INVENTION

Combining an electric carving knife and an electric mixer into one device is a known concept, yet previous inventions have necessitated the use of separate receiving chambers in the main housing for the knife and mixer attachments. The present invention employs one receiving chamber in the main housing for both attachments. The advantage of this is that less technical equipment is needed within the main housing.

When separate points of entry are used on a mixing device, it is necessary to have within the main housing the technical means to apply rotary motion to the mixer attachment and linear motion to the knife attachment. The present invention, however, needs only to produce linear motion within the main housing, allowing for a simpler design. The rotary motion needed to turn the whisk of the mixer attachment is produced outside of the main housing, by a motion converter placed within the mixer attachment itself. This motion converter translates linear motion into rotary motion by known, conventional means. The advantage gained is that any problems in producing a rotary motion can be resolved by the replacement of the mixer attachment rather than by replacement of the main housing. This is a difference from prior electric knife/mixer devices.

U.S. Pat. No. 5,316,382 is for “Electrically Driven Hand Mixer with Knife-Like Tool Interlock” issued to Penaranda et al. on May 31, 1994. Penaranda et al. uses one receiving chamber for a mixer attachment and a knife-like tool attachment, but unlike the present invention, Peneranda et al.'s knife-like tool attachment moves in a rotary motion, whereas the present invention's knife attachments move in a back-and-forth, linear motion.

U.S. Pat. No. 3,533,600 is for “Combination Rotary Beater and Reciprocating Knife Kitchen Appliance” issued to Gerson on Oct. 13, 1970, and U.S. Pat. No. 3,595,093 is for “Electric Kitchen Appliance” issued to Du Bois et al. on Jul. 27, 1971. Both Gerson and Du Bois et al. employ separate points of entry for the knife and mixer attachments, whereas the present invention employs one receiving chamber for the knife and mixer attachments.

### SUMMARY OF THE PRESENT INVENTION

The present invention is a combination electric carving knife and mixer, embodying both knife and mixer functions in a single device, and constructed so that cutting blades and mixer attachment utilize the same receiving chamber. The basic composition of the present invention is a main housing with an electrical power cord, a motor and gears to move the cutting blades and mixer attachment, an on/off switch, a pressure-sensitive safety toggle switch, a speed setting switch, an attachment release button, a mixer attachment, cutting blade attachments, a blade lock lever, and a single receiving chamber in which to insert the attachments.

The present invention functions to reduce kitchen clutter and provide easier access to needed kitchen appliances, allowing a cook to switch from a cutting function to a mixing function quickly and easily. Rather than purchasing both an electric knife and an electric mixer, the cook can use the present invention to accomplish both functions by utilizing attachments that are inserted into the identical receiving chamber. In addition, the present invention main housing needs only to produce linear motion, whereas previous knife/mixer devices were required to produce both linear and rotary motion within a main housing. The rotary motion needed to turn the whisk of the mixer attachment is produced outside of the main housing, by a conventional motion converter placed within the mixer attachment itself. The advantage gained is that any problems in producing a rotary motion can be resolved by the replacement of the mixer attachment rather than replacement of the main housing.

The present invention has at least three attachments, at least two cutting blades and one mixer attachment. The cutting blades will comprise at least one blade for cutting hard or frozen foods and at least one blade for cutting softer foods. The mixer attachment is made of materials durable enough to mix ingredients at high speeds.

### BRIEF DESCRIPTION OF THE DRAWINGS

FIG. 1 is a side view of the present invention in its preferred embodiment.

FIG. 2A shows the attachments of the present invention in their preferred embodiment, namely the serrated blade (30), the smooth blade (40), and the mixer attachment (50).

FIG. 2B shows a top, cutaway view of the motion converter (200) of the mixer attachment (50) in order to reveal its inner workings

FIG. 3 is a side cutaway view of the interior portion of the main housing (10) of the present invention, showing the inner workings of the present invention with a serrated blade (30) attachment inserted into the receiving chamber (90).

FIG. 4 is a side cutaway view of the interior portion of the main housing (10) of the present invention, showing the inner workings of the main housing (10) with the mixer attachment (50) inserted into the receiving chamber (90).

### DETAILED DESCRIPTION OF THE PRESENT INVENTION

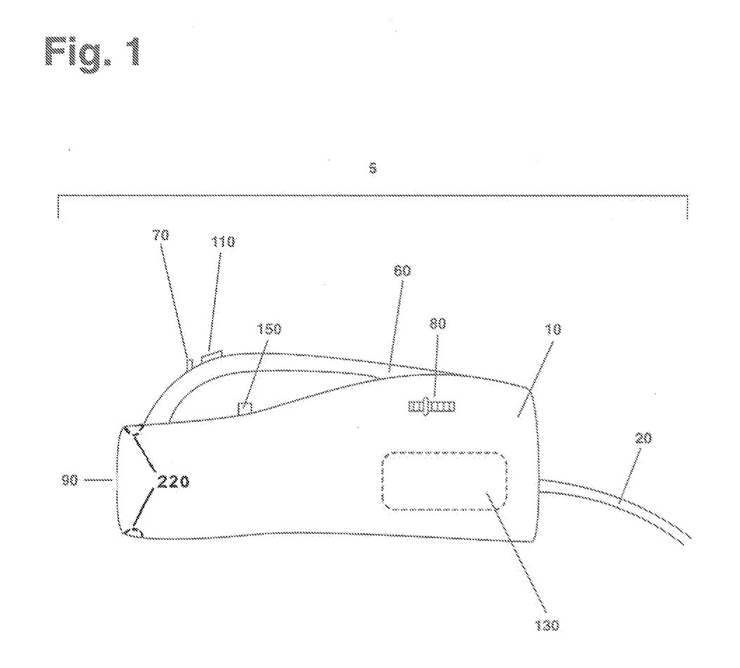

FIG. 1 is a side view of the present invention in its preferred embodiment. The main housing (10) is preferably constructed with a waterproof hard shell casing of a durable rigid material with a handle (60). The motor (130) is placed inside the main housing (10), and operates with 120 volt AC power by means of the power cord (20). The motor (130) is engaged and controlled by the on/off switch (70), the speed setting switch (80), and the pressure-sensitive safety toggle switch (110). The speed setting switch (80) has eight to ten speeds. The pressure-sensitive safety toggle switch (110) powers off the present invention if the user is not actively engaging the switch (110), ensuring the present invention will shut off if the user drops it or otherwise loses control of it. All elements of the present invention are of conventional design employing conventionally known technology.

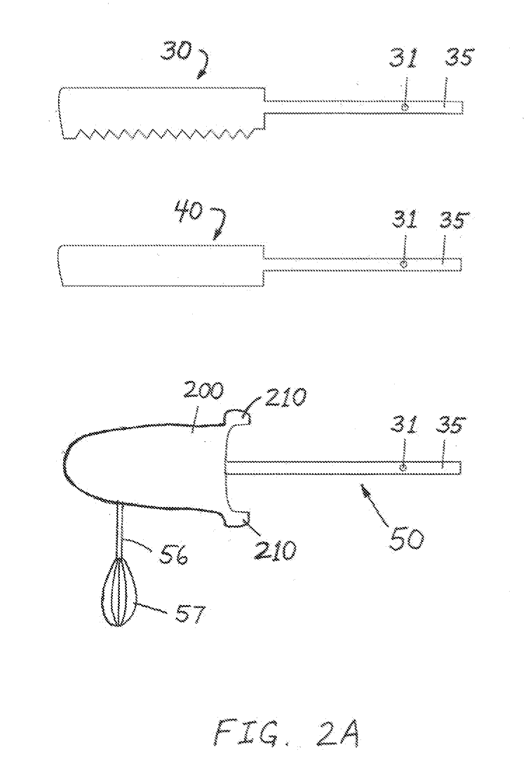

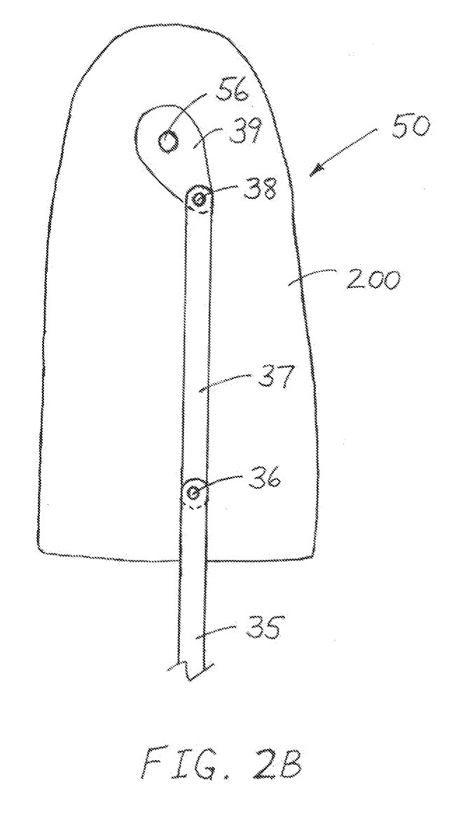

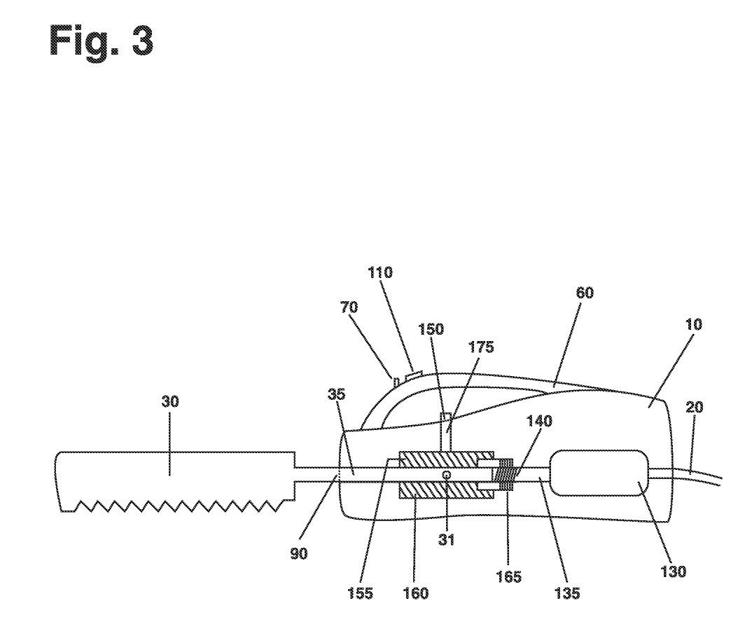

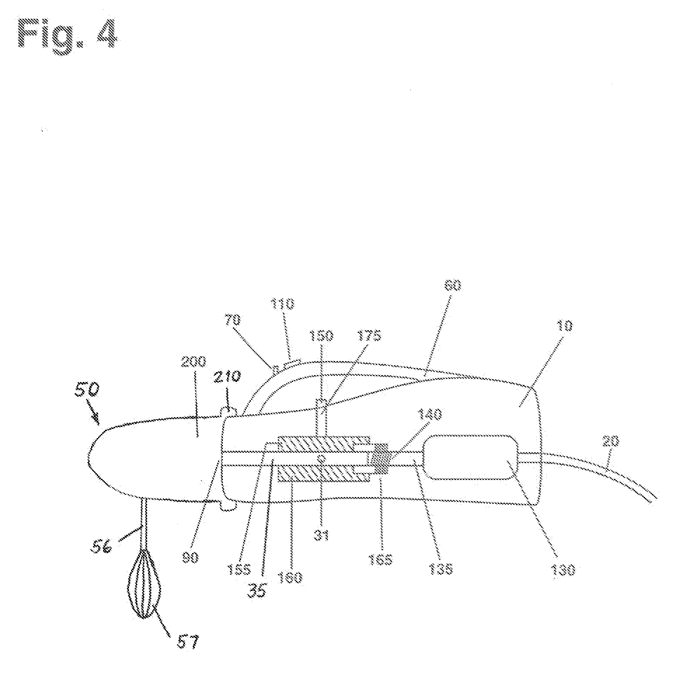

The present invention, as shown in FIG. 1, also features a receiving chamber (90) and an attachment release button (150). When one of the attachments (see FIG. 2A) is inserted into the receiving chamber (90), it locks in place (see FIGS. 3 and 4) and is released by depressing the attachment release button (150) on the outside of the main housing (10). The receiving chamber (90) and attachment release button (150) all operate via conventionally known ways of interaction and structure. Also shown in FIG. 1 are the indentations (220) by which the mixer attachment (50) (not shown in FIG. 1, see FIG. 2A) attaches to the main housing (10).

FIG. 2A shows the attachments of the present invention in their preferred embodiment, namely the serrated blade (30), the smooth blade (40), and the mixer attachment (50). The serrated blade (30) is for cutting hard or frozen foods (e.g., whole chicken, whole turkey, meat, pork, fish, etc.), the smooth blade (40) is for cutting softer foods (e.g., vegetables, fruits, bread, cheese, sausage, ham, etc.), and the mixer attachment (50) is for conventional mixing tasks. The serrated blade (30) and the smooth blade (40) are envisioned in the preferred embodiment as made of a resilient heavy-duty steel such as stainless steel. Additional blades designed for cutting other objects may also be utilized. The mixer attachment attaches to the front of the main housing (10) (not shown in FIG. 2A, see FIG. 1) by means of tabs (210) that fit into indentations (220) (not shown in FIG. 2A, see FIG. 1). The mixer attachment (50) contains a motion converter (200) that translates the linear motion of the pistons (155 and 160) (not shown in FIG. 2A, see FIG. 1) to a rotary motion, using known conventional means (see FIG. 2B). The rotary motion spins the whisk rod (56) and whisk (57) of the mixer attachment (50). The user can completely remove the blades (30 and 40) and mixer attachment (50) from the receiving chamber (90) (see FIG. 1) so that each attachment can be cleaned properly. Each of the attachments (30, 40 and 50) has a shank section (35) with an attachment lock opening (31) that connects to the attachment lock lever (175) (see FIGS. 3 and 4) in order to hold the attachments (30, 40 and 50) in place.

FIG. 2B shows a top, cutaway view of the motion converter (200) of the mixer attachment (50) in order to reveal its inner workings The technology used in the motion converter (200) is conventionally known. The shank section (35) connects to one end of a pivot rod (37) by means of a first pivot (36). The opposite end of the pivot rod (37) connects by means of a second pivot (38) to a crank (39) that connects to the whisk rod (56) (not visible due to angle of view, see FIG. 2A). By these parts, the motion converter (200) converts the linear motion of the shank section (35) to the rotary motion of the crank (39).

FIG. 3 is a side cutaway view of the interior portion of the main housing (10) of the present invention, showing the inner workings of the present invention with a serrated blade (30) attachment inserted into the receiving chamber (90). The present invention has a 120-volt AC motor (130) with eight to ten speed settings. The motor (130) drives a rotating shaft (135) that turns at 200-450 revolutions per minute to drive two pistons (155 and 160) that provide the back-and-forth, linear motion to move the serrated blade (30). The shank section (35) of the serrated blade (30) is inserted into the receiving chamber (90) of the main housing (10). It should be understood that the receiving chamber (90) is defined as the region between said pistons (155 and 160) at a first end of said receiving chamber (90), and defined as the region between said main housing (10) at a second end of said receiving chamber (90). The shank section (35) is held in place by the attachment lock lever (175), which inserts into an attachment lock opening (31) located on the shank section (35). Upon actuation by the on/off switch (70) and the safety toggle switch (110), the motor (130) begins to rotate the rotating shaft (135). The rotating shaft (135) includes a threaded rod (140) located at one end of the shaft. The threaded rod (140) engages the gear assembly (165), of conventional design, translating the rotation of the rotating shaft (135) to the reciprocating action of the pistons (155 and 160). The pistons (155 and 160) drive forward and back, thus causing the shank section (35) and attached serrated blade (30) to move back and forth in a linear, cutting motion. Although a gear assembly (165) is used, it should be understood that any mechanism that allows the motor (130) to drive the serrated blade (30) in a cutting motion may be used. Use of an electric motor (130) to move a blade is well known in the art of electric knives. When the user desires to stop cutting, he or she releases the safety toggle switch (110), thereby stopping the motor (130). The serrated blade (30) is removed from the receiving chamber (90) by pressing the attachment release button (150). Also shown in FIG. 3 are the power cord (20) and the handle (60).

FIG. 4 is a side cutaway view of the interior portion of the main housing (10) of the present invention, showing the inner workings of the main housing (10) with the mixer attachment (50) inserted into the receiving chamber (90). The present invention has a 120-volt AC motor (130) with eight to ten speed settings. The motor (130) drives a rotating shaft (135) that preferably turns at 200-450 revolutions per minute to drive two pistons (155 and 160). The shank section (35) of the mixer attachment (50) is inserted into the receiving chamber (90) of the main housing (10). It should be understood that the receiving chamber (90) is defined as the region between said pistons (155 and 160) at a first end of said receiving chamber (90), and defined as the region between said main housing (10) at a second end of said receiving chamber (90). The shank section (35) is held in place by the attachment lock lever (175), which inserts into an attachment lock opening (31) located on the shank section (35). Upon actuation by the on/off switch (70) and the safety toggle switch (110), the motor (130) begins to rotate the rotating shaft (135). The rotating shaft (135) includes a threaded rod (140) located at one end of the shaft (135). The threaded rod (140) engages the gear assembly (165), of conventional design, translating the rotation of the rotating shaft (135) to the reciprocating action of the pistons (155 and 160). The pistons (155 and 160) drive forward and back, thus causing the shank section (35) to move in a back-and-forth, linear motion. This linear motion is then translated into a rotary motion by the mixer motion converter (200), which is part of the mixer attachment (50) that attaches to the outside of the main housing (10) by means of tabs (210) that fit into indentations (220) (not shown in FIG. 4, see FIG. 1). The motion converter (200) employs known, conventional technical means to translate the linear motion of the pistons (155 and 160) to a spinning motion (see FIG. 2B), such motion being imparted to the whisk rod (56) and whisk (57). The mixer attachment (200) is removed from the receiving chamber (90) by pressing the attachment release button (150) and removing the tabs (210) from the main housing (10). Also shown in FIG. 4 are the power cord (20) and handle (60).

Another embodiment of the present invention may include the capability to use the present invention in a cordless mode, i.e. powered by batteries. In this embodiment, the device will have a battery slot and the capability to operate on battery power, whether the batteries are of the rechargeable or non-rechargeable variety.

Another embodiment of the present invention may include a storage compartment built into the housing of the present invention itself. This feature would further reduce the amount of space needed to store the present invention and its attachments, and would keep at least one attachment tucked away safely, reducing the possibility of an accident and preserving the attachment.

In summary, the present invention is a knife and mixer device, comprising a main housing (10), a motor (130) inside the main housing (10), a rotating shaft (135) disposed from the motor (130), a threaded rod (140) disposed at one end of the rotating shaft (135), a gear assembly (165) in communication with the threaded rod (140), pistons (155 and 160) in communication with the gear assembly (165), a receiving chamber (90) defined as the region between the pistons (155 and 160) at a first end of the receiving chamber (90) and defined as the region between the main housing (10) at a second end of the receiving chamber (90), a serrated blade (30) configured to fit in the receiving chamber (90), a smooth blade (40) configured to fit in the receiving chamber (90), and a mixer attachment (50) configured to fit in the receiving chamber (90).

In addition, the present invention's mixer attachment (50) comprises a motion converter (200) that translates linear motion into rotary motion, and comprises a shank section (35), a first pivot (36), a pivot rod (37), a second pivot (38), a crank (39), a whisk rod (56), and a whisk (57).

I claim:

1. A knife and mixer device, comprising:
a main housing;
a motor, inside said main housing;
a rotating shaft, disposed from said motor;
a threaded rod, disposed at one end of said rotating shaft;
a gear assembly, in communication with said threaded rod;
pistons, in communication with said gear assembly;
a receiving chamber defined as the region between said pistons at a first end of said receiving chamber, and defined as the region between said main housing at a second end of said receiving chamber;
a serrated blade, configured to fit in said receiving chamber;
a smooth blade configured to fit in said receiving chamber; and
a mixer attachment configured to fit in said receiving chamber.

2. The knife and mixer device of claim 1, wherein said mixer attachment comprises a motion converter, said motion converter translating linear motion into rotary motion.

3. The knife and mixer device of claim 1, wherein said mixer attachment comprises a shank section, a first pivot, a pivot rod, a second pivot, a crank, and a whisk rod.

4. The knife and mixer device of claim 1, wherein said mixer attachment comprises a whisk rod and a whisk.

5. The knife and mixer device of claim 2, wherein said mixer attachment comprises a shank section, a first pivot, a pivot rod, a second pivot, a crank, and a whisk rod.

6. The knife and mixer device of claim 2, wherein said mixer attachment comprises a whisk rod and a whisk.

7. The knife and mixer device of claim 3, wherein said mixer attachment comprises a whisk rod and a whisk.
